(19) United States
(12) Patent Application Publication
(10) Pub. No.: US 2026/0321500 A1
(43) Pub. Date: Oct. 15, 2026

(54) MULTILAYER ELECTRONIC COMPONENT

(71) Applicant: SAMSUNG ELECTRO-MECHANICS CO., LTD., Suwon-si (KR)

(72) Inventors: Hwa Pyeong YANG, Suwon-si (KR); Young Hoon SONG, Suwon-si (KR); Jin Hyung LIM, Suwon-si (KR); Hyuk Jin HONG, Suwon-si (KR)

(73) Assignee: SAMSUNG ELECTRO-MECHANICS CO., LTD., Suwon-si (KR)

(21) Appl. No.: 19/562,119

(22) Filed: Mar. 10, 2026

(30) Foreign Application Priority Data
Apr. 10, 2025 (KR) 10-2025-0046878

(51) Int. Cl. H01G 4/224; H01G 4/012; H01G 4/12; H01G 4/30

(52) U.S. Cl. CPC H01G 4/224; H01G 4/012; H01G 4/12; H01G 4/30

(57) ABSTRACT

A multilayer electronic component includes a body having a stack body in which multiple first dielectric layers and multiple internal electrodes are alternately stacked in a first direction. A protection portion of dielectric grains is disposed on the stack body and includes a first region in contact with the stack body and a second region on the first region, the regions having different average densities. External electrodes are on third and fourth surfaces of the body and are connected to the internal electrodes. At least one of the first, second, fifth, and sixth surfaces includes a concavity recessed toward the stack body.

### CROSS-REFERENCE TO RELATED APPLICATIONS

This application claims benefit of priority to Korean Patent Application No. 10-2025-0046878 filed on Apr. 10, 2025, in the Korean Intellectual Property Office, the disclosure of which is incorporated herein by reference in its entirety.

### TECHNICAL FIELD

The present disclosure relates to a multilayer electronic component.

A Multilayer Ceramic Capacitor (MLCC), a multilayer electronic component, is a chip‑sized capacitor mounted on the printed circuit boards (PCBs) of various electronic devices, including video displays (LCDs, PDPs), computers, smartphones, and other mobile devices, as well as onboard chargers (OBC) and DC–DC converters for electric vehicles, to charge and discharge electrical energy. As electronics become smaller and more multifunctional, chip components are likewise miniaturized and enhanced in functionality, and multilayer ceramic electronic components must therefore combine reduced size with high capacitance.

Conventionally, margin regions have been formed by (i) making the dielectric layer area larger than that of the internal electrodes, which leaves a margin except where the internal electrodes connect to the external electrodes, or (ii) attaching a separate sheet‑shaped margin.

However, enlarging the dielectric layer area relative to the internal electrodes to create the margin region can introduce step‑height differences that warp ends of the internal electrodes due to variations in stacking; and when a margin portion is formed by attaching a separate sheet‑shaped margin portion, differences in shrinkage and thermal expansion between the margin and the capacitance‑forming portion generate in‑plane mechanical stress along their bonding interface. Such warpage and interface stress can cause cracks in the multilayer electronic component and degrade moisture‑resistance reliability. Thus, there is a need for new and improved multilayer electronic components combine reduced size with high capacitance.

### SUMMARY

One of the various aspects of the present disclosure is to prevent an end of an internal electrode from being warped due to a step portion caused by a difference in a degree of lamination of internal electrodes, when a first dielectric layer is formed to have a larger area than that of the internal electrode to form a margin region in the remaining region excluding a portion in which the internal electrode is connected to the external electrode.

One of the various aspects of the present disclosure is to alleviate the problem of cracks occurring at an interface due to differences in shrinkage and expansion rates between a stack body and a margin portion, and between the stack body and a cover portion, when separate sheets are attached to a fifth side surface and a sixth side surface of the stack body to form the margin portion and are attached to a first side surface and a second side surface to form the cover portion.

However, the aspects of the present disclosure are not limited to the above-described content, and will be more readily understood in a process of describing specific example embodiments of the present disclosure.

A multilayer electronic component according to an example embodiment of the present disclosure may include: a body including a stack body including a first dielectric layer and an internal electrode alternately disposed with the first dielectric layer in a first direction, and a protection portion disposed on the stack body and including dielectric grains, and including a first surface and a second surface opposing each other in the first direction, a third surface and a fourth surface connected to the first surface and the second surface and opposing each other in a second direction, and a fifth surface and a sixth surface connected to the first to fourth surfaces and opposing each other in a third direction; and an external electrode disposed on the third surface and the fourth surface and connected to the internal electrode, and the protection portion may include a first region in contact with the stack body, and a second region disposed on the first region, when an average density of the first region is defined as D1 and an average density of the second region is defined as D2, D1 and D2 may be different, and one or more surfaces of the first surface, the second surface, the fifth surface or the sixth surface may include a concave portion having a concave shape toward the stack body.

An effect of the present disclosure is to suppress or mitigate cracking in a multilayer electronic component.

An effect of the present disclosure is to improve the moisture resistance reliability of a multilayer electronic component.

An effect of the present disclosure is to improve the mechanical strength of a multilayer electronic component.

An effect of the present disclosure is to differently control the characteristics of each region of a protection layer disposed on a stack body in different areas.

However, advantages and effects of the present disclosure are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an example embodiment of the present disclosure;

FIG. 2 schematically illustrates a perspective view of a body according to an example embodiment of the present disclosure;

FIG. 3 schematically illustrates a cross-sectional view taken along line I-I’ of FIG. 1;

FIG. 4 schematically illustrates a cross-sectional view taken along line II-II’ of FIG. 1;

FIG. 5 schematically illustrates a perspective view of a multilayer electronic component according to another example embodiment of the present disclosure;

FIG. 6 schematically illustrates a perspective view of a body according to another example embodiment of the present disclosure;

FIG. 7 schematically illustrates a cross-sectional view taken along line III-III’ of FIG. 5;

FIG. 8 schematically illustrates a cross-sectional view taken along line IV-IV’ of FIG. 5;

FIG. 9 schematically illustrates an operation of stacking a dielectric sheet and an internal electrode pattern according to an example embodiment;

FIG. 10 schematically illustrates an operation of cutting a stack bar according to an example embodiment;

FIG. 11 schematically illustrates a state in which a first cut bar is formed after an operation of cutting a stack bar according to an example embodiment is performed;

FIG. 12 schematically illustrates an operation of forming a second cut bar by wrapping a first protection sheet around a first cut bar according to an example embodiment;

FIG. 13 schematically illustrates an operation of forming a third cut bar by wrapping a second protection sheet around a second cut bar according to an example embodiment; and

FIG. 14 schematically illustrates an operation of forming an unsintered body by cutting the third cut bar.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In addition, in the drawing, an X-direction may mean a thickness direction, a Y-direction may mean a longitudinal direction, and a Z-direction may mean a width direction, and a stacking direction of internal electrodes or dielectric layers may be a thickness direction or a width direction.

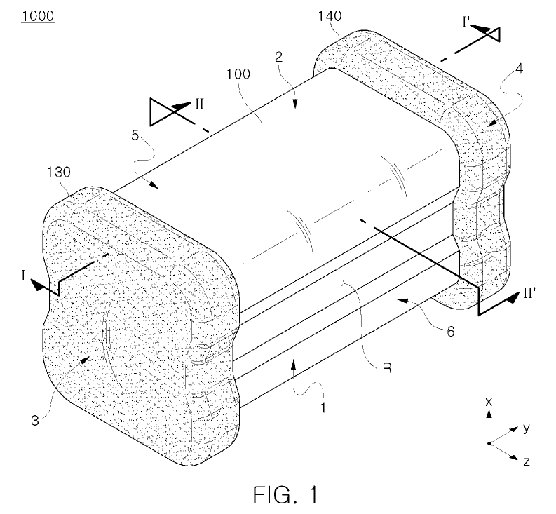

FIG. 1 schematically illustrates a perspective view of a multilayer electronic component according to an example embodiment of the present disclosure.

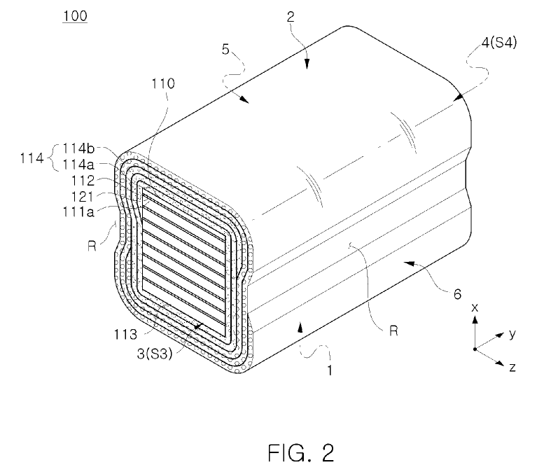

FIG. 2 schematically illustrates a perspective view of a body according to an example embodiment of the present disclosure.

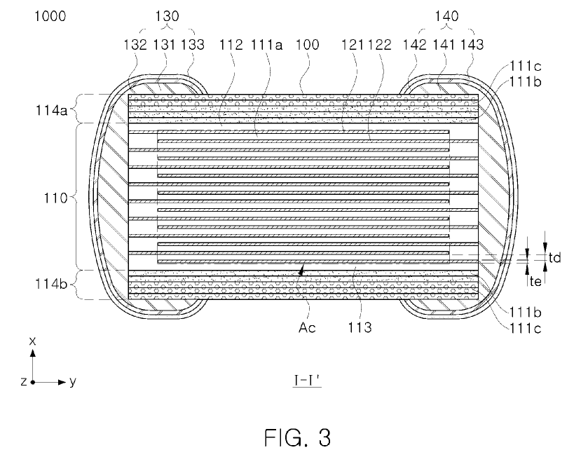

FIG. 3 schematically illustrates a cross-sectional view taken along line I-I’ of FIG. 1.

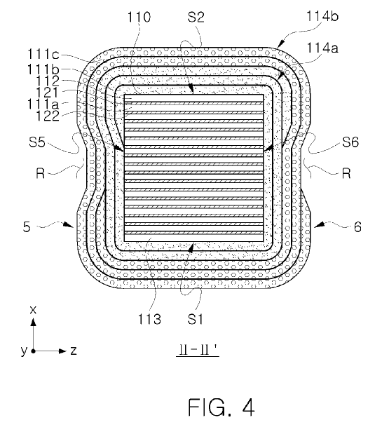

FIG. 4 schematically illustrates a cross-sectional view taken along line II-II’ of FIG. 1.

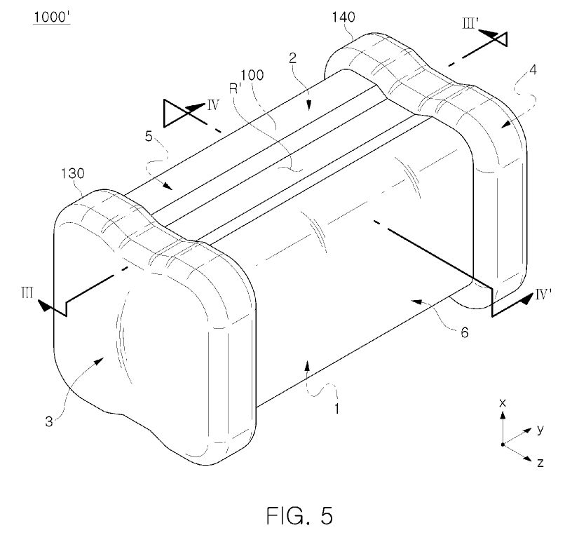

FIG. 5 schematically illustrates a perspective view of a multilayer electronic component according to another example embodiment of the present disclosure.

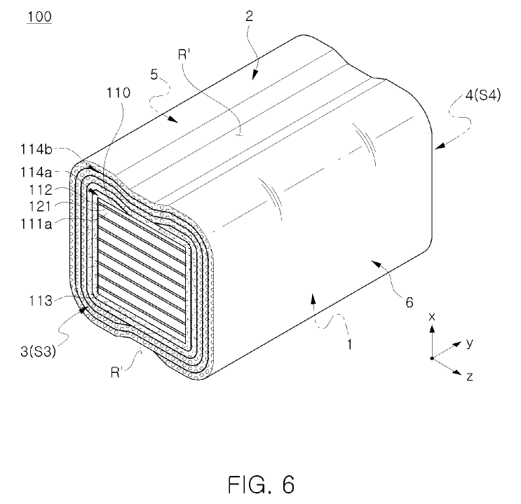

FIG. 6 schematically illustrates a perspective view of a body according to another example embodiment of the present disclosure.

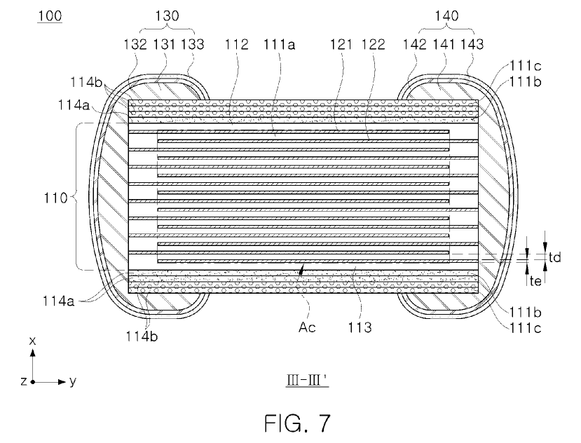

FIG. 7 schematically illustrates a cross-sectional view taken along line III-III’ of FIG. 5.

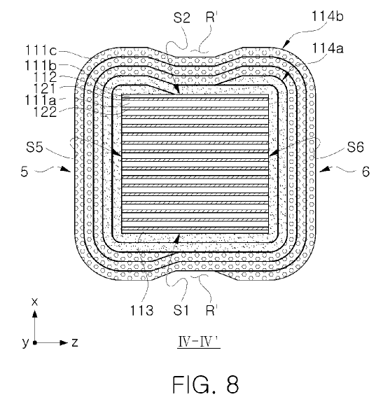

FIG. 8 schematically illustrates a cross-sectional view taken along line IV-IV’ of FIG. 5.

Hereinafter, with reference to FIGS. 1-8, a multilayer electronic component 1000 and 1000’ according to an example embodiment of the present disclosure and various example embodiments thereof will be described in detail. However, in order to avoid redundant description, the following description will focus on the multilayer electronic component 1000 according to an example embodiment of FIGS. 1-4, and the description below may also be applied to a multilayer electronic component 1000’ according to an example embodiment of FIGS. 5-8.

A multilayer electronic component 1000 according to an example embodiment of the present disclosure may include a body 100 including a stack body 110 including a first dielectric layer 111a and internal electrodes 121 and 122 disposed alternately with the first dielectric layer 111a in a first direction, and a protection portion 114 disposed on the stack body 110 and including dielectric grains, and including a first surface 1 and a second surface 2 opposing each other in the first direction, a third surface 3 and a fourth surface 4 connected to the first surface 1 and the second surface 2 and opposing each other in the second direction, and a fifth surface 5 and a sixth surface 6 connected to the first to fourth surfaces 1, 2, 3 and 4 and opposing each other in the third direction, and external electrodes 130 and 140 disposed on the third surface 3 and the fourth surface 4 and connected to the internal electrodes 121 and 122, and the protection portion 114 may include a first region 114a in contact with the stack body 110 and a second region 114b disposed on the first region 114a, and when an average density of the first region 114a is defined as D1 and an average density of the second region 114b is defined as D2, D1 and D2 may be different, and two or more surfaces of the first surface 1, the second surface 2, the fifth surface 5 and the sixth surface 6 may include concave portions R and R’ having a concave shape toward the stack body 110.

Referring to FIGS. 2 and 6, the body 100 may include a stack body 110 and a protection portion 114 disposed on the stack body 110, and may include the first surface 1 and the second surface 2 opposing each other in the first direction, the third surface 3 and the fourth surface 4 connected to the first surface 1 and the second surface 2 and opposing each other in the second direction, and the fifth surface 5 and the sixth surface 6 connected to the first to fourth surfaces 1, 2, 3 and 4 and opposing each other in the third direction.

Referring to FIGS. 3 and 7, the first dielectric layer 111a and the internal electrodes 121 and 122 may be stacked in the first direction, but the present disclosure is not limited thereto, and the first dielectric layer 111a and the internal electrodes 121 and 122 may also be stacked in the second direction or the third direction.

Referring to FIGS. 2, 4, 6 and 8, the stack body 110 may include a first dielectric layer 111a and internal electrodes 121 and 122, and referring to FIGS. 2-8, the stack body 110 may include a first side surface S1 and a second side surface S2 opposing each other in the first direction, a third side surface S3 and a fourth side surface S4 connected to the first side surfaceS1 and the second side surface S2 and opposing each other in the second direction, and a fifth side surface S5 and a sixth side surface S6 connected to the first to fourth side surfaces S1, S2, S3 and S4 and opposing each other in the third direction.

The stack body 110 may include a capacitance formation portion Ac which is a region in which the first dielectric layer 111a and the internal electrodes 121 and 122 overlap each other in the first direction, and cover portions 112 and 113 disposed on one surface and the other surface of the capacitance formation portion Ac in the first direction.

A side surface of a portion of the stack body 110 may be sintered to form a surface of the body 100, and a protection portion 114 may be disposed on the side surface of a portion of the stack body 110. Specifically, the third side surface S3 of the stack body 110 may be a portion of the third surface 3 of the body 100, and the fourth side surface S4 of the stack body 110 may be a portion of the fourth surface 4 of the body 100, and the protection portions 114 may be disposed on the first side surface S1, the second side surface S2, the fifth side surface S5 and the sixth side surface S6 of the stack body 110.

The first dielectric layer 111a is in a sintered state, and boundaries between adjacent first dielectric layers 111a may be integrated, so as to be difficult to identify without using a scanning electron microscope (SEM).

The raw material included in the first dielectric layer 111a is not particularly limited, as long as the material may achieve sufficient electrostatic capacitance. For example, barium titanate-based materials, lead composite perovskite-based materials, or strontium titanate-based materials may be used as the material.

The first dielectric layer 111a may include a BaTiO₃-based dielectric material. Examples of dielectric materials include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), which is formed by partially employing calcium (Ca) and zirconium (Zr) in BaTiO₃.

Furthermore, the raw material included in the first dielectric layer 111a may be obtained by adding various ceramic additives, organic solvents, binders, dispersants, or the like, to powder particles such as barium titanate (BaTiO₃), depending on the purpose of the present disclosure.

An average thickness td of the first dielectric layer 111a need not be specifically limited. For example, in order to achieve the miniaturization and the high capacitance of the multilayer electronic component 1000, the average thickness td of the first dielectric layer 111a may be 0.35 μm or less, and in order to improve the reliability of the multilayer electronic component 1000 under high temperature and high voltage, the average thickness td of the first dielectric layer 111a may be 1 μm or more.

Meanwhile, when the average thickness td of the first dielectric layer 111a is 0.35 μm or less, controlling the density of the protection portion 114 disposed on the stack body 110 may be more decisive for ensuring target capacitance performance and reliability of the multilayer electronic component 1000. That is, when the average thickness td of the first dielectric layer 111a is 0.35 µm or less, it may be difficult to achieve the target capacitance performance characteristics of the multilayer electronic component 1000 while improving moisture resistance reliability, suppressing crack occurrence, or ensuring mechanical strength.

However, according to an example embodiment of the present disclosure, the protection portion 114 may be divided into two regions having different density, concave portions R and R’ in which two or more surfaces of the first surface, the second surface, the fifth surface and the sixth surface of the body have a concave shape toward the stack body 110 may be included, so that the reliability of the multilayer electronic component 1000 may be improved, and even when the average thickness td of the first dielectric layer 111a is 0.35 µm or less, the moisture resistance reliability of the multilayer electronic component 1000 may be improved, crack occurrence may be suppressed, or mechanical strength may be secured. However, it should be noted that the description does not limit the average thickness td of the first dielectric layer 111a of the present disclosure to 0.35 μm or less.

The average thickness td of the first dielectric layer 111a may refer to an average thickness of one or more first dielectric layers among the plurality of first dielectric layers in the first direction.

The average thickness of the first dielectric layer 111a in the first direction may be measured by scanning an image of first and second directional cross-sections of the multilayer electronic component 1000 using a scanning electron microscope (SEM) at 10,000X magnification. More specifically, the average thickness of a single first dielectric layer 111a in the first direction may refer to an average value calculated by measuring a first directional thickness of a single first dielectric layer 111a at four or more points spaced apart from each other by equal intervals in the second direction in the scanned image. The four or more equally spaced points may be designated by the capacitance formation portion (Ac). Furthermore, when measuring an average value thereof by expanding the average value measurement to four or more first dielectric layers 111a, an average thickness of the first dielectric layer 111a in the first direction may be further generalized.

Referring to FIGS. 3, 4, 5, 6, and 7 cover portions 112 and 113 may be disposed on one surface and the other surface of the capacitance formation portion Ac in the first direction.

The cover portions 112 and 113 may be formed by stacking a single dielectric layer or two or more dielectric layers on the one surface and the other surface of the capacitance formation portion Ac in the first direction, respectively, and the cover portions 112 and 113 may fundamentally serve to prevent damage to the internal electrodes due to physical or chemical stress.

The cover portions 112 and 113 do not include internal electrodes and may include substantially the same material as the first dielectric layer 111a.

An average thickness of the cover portions 112 and 113 need not be specifically limited. However, according to an example embodiment of the present disclosure, since the protection portion 114 is disposed on the stack body 110, even when the average thickness of the cover portions 112 and 113 is substantially equal to the average thickness of the first dielectric layer 111a, the moisture resistance reliability and mechanical strength of the multilayer electronic component 1000 may be secured.

The average thickness of the cover portions 112 and 113 may refer to a first directional thickness of each of a first cover portion 112 and a second cover portion 113, and may be a value obtained by averaging the first directional thicknesses of the cover portions 112 and 113 measured at five points spaced apart from each other by equal intervals in an upper portion or a lower portion of the capacitance formation portion Ac.

The internal electrodes 121 and 122 may be disposed alternately with the first dielectric layer 111a in the first direction, and the internal electrodes 121 and 122 may include first and second internal electrodes 121 and 122. Referring to FIGS. 2, 3, and 4, the first and second internal electrodes 121 and 122 may be disposed alternately to face each other with the first dielectric layer 111a interposed therebetween, and may be connected to one or more of the third to sixth side surfaces S3, S4, S5 or S6 of the stack body 110.

Specifically, one end of a first internal electrode 121 in the second direction may be connected to the third side surface S3, and the other end of the second direction may be spaced from the fourth side surface S4. One end of a second internal electrode 122 in the second direction may be connected to the fourth side surface S4, and the other end of the second direction may be spaced from the third side surface S3. In this case, the first and second internal electrodes 121 and 122 may be electrically isolated from each other by the first dielectric layer 111a disposed in the middle.

Referring to FIG. 4, both ends of the first internal electrode 121 in the third direction and both ends of the second internal electrode 122 in the third direction may be simultaneously connected to the fifth side surface S5 and the sixth side surface S6. Accordingly, the proportion of the capacitance formation portion Ac in the overall component may be increased to maximize the capacitance per unit volume of the multilayer electronic component 1000, and the phenomenon of warping internal electrodes 121 and 122 due to step portions may be mitigated.

The material included in the internal electrodes 121 and 122 is not particularly limited, and any material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), or alloys thereof.

Additionally, the internal electrodes 121 and 122 may be formed by printing a conductive paste for internal electrodes, including one or more of nickel (Ni), copper (Cu), palladium (Pd), silver (Ag), gold (Au), platinum (Pt), tin (Sn), tungsten (W), titanium (Ti), or alloys thereof, onto a ceramic green sheet. A printing method for the conductive paste for internal electrodes may use a screen printing method or a gravure printing method, and the present disclosure is not limited thereto.

Meanwhile, a thickness te of the internal electrodes 121 and 122 need not be particularly limited. In order to achieve miniaturization and the high capacitance of a multilayer electronic component 1000, the average thickness te of the internal electrodes 121 and 122 may be 0.35 μm or less, and in order to improve the reliability of the multilayer electronic component 1000 under high temperature and high voltage conditions, the average thickness te of the internal electrodes 121 and 122 may be 1 μm or more.

Meanwhile, when the average thickness te of the internal electrodes 121 and 122 is 0.35 μm or less, controlling the density of the protection portion 114 disposed on the stack body 110 may be more decisive for ensuring the target capacitance performance and reliability of the multilayer electronic component 1000. That is, when the average thickness te of the internal electrodes 121 and 122 is 0.35 µm or less, it may be difficult to achieve the target capacitance performance characteristics of the multilayer electronic component 1000 while improving moisture resistance reliability, suppressing crack occurrence, or ensuring mechanical strength.

However, according to an example embodiment of the present disclosure, the protection portion 114 may be divided into two regions having different densities, and concave portions R and R’ in which two or more surfaces of the first, second, fifth and sixth surfaces of the body have a concave shape toward the stack body 110 may be included, so that the reliability of the multilayer electronic component 1000 may be improved, and even when the average thickness te of the internal electrodes 121 and 122 is 0.35 µm or less, the moisture resistance reliability of the multilayer electronic component 1000 may be improved, crack occurrence may be suppressed, and mechanical strength may be secured. However, it should be noted that the description does not limit the average thickness te of the internal electrodes 121 and 122 of the present disclosure to 0.35 μm or less.

The average thickness te of the internal electrodes 121 and 122 may refer to an average thickness one or more internal electrodes 121 and/or 122 in the first direction, among the plurality of internal electrodes 121 and/or 122.

The average thickness of the internal electrodes 121 and 122 in the first direction may be measured by scanning an image of the first and second directional cross-sections of the multilayer electronic component 1000, using a scanning electron microscope (SEM) at 10,000X magnification. More specifically, the average thickness of one internal electrode in the first direction may be an average value calculated by measuring first directional thicknesses at four or more points of one internal electrode spaced apart from each other at equal intervals in the second direction in the scanned image. The four or more equally spaced points described above may be designated by the capacitance formation portion Ac. Furthermore, when measuring an average value thereof by expanding the average value measurement to four or more internal electrodes 121 and 122, an average thickness of the internal electrodes 121 and 122 in the first direction may be further generalized.

Referring to FIGS. 1 and 5, the external electrodes 130 and 140 may be disposed on the body 100 including stack body 110 and the protection portion 114.

Specifically, the first external electrode 130 may be disposed on the third surface 3 of the body 100 and connected to the first internal electrode 121, and the second external electrode 140 may be disposed on the fourth surface 4 of the body 100 and connected to the second internal electrode 122.

Although this example embodiment describes the multilayer electronic component 1000 having two external electrodes 130 and 140, the number and shape of the external electrodes 130 and 140 may vary depending on the shape of the internal electrodes 121 and 122 or other purposes.

Meanwhile, the external electrodes 130 and 140 may be formed using any material that is electrically conductive, such as metal, and a specific material may be determined based on electrical characteristics, structural stability, or the like, and the external electrodes 130 and 140 may further have a multilayer structure.

Referring to FIGS. 3 and 7, the external electrodes 130 and 140 may include electrode layers 131 and 141 in contact with the body 100 and plating layers 132, 133, 142 and 143 disposed on the electrode layers 131 and 141.

For more specific examples of the electrode layers 131 and 141, the electrode layers 131 and 141 may be sintered electrodes including a conductive metal and glass, or resin-based electrodes including a conductive metal and a resin.

Furthermore, the electrode layers 131 and 141 may be formed by sequentially forming the sintered electrodes and the resin-based electrodes on the body 100. Furthermore, the electrode layers 131 and 141 may be formed by transferring a sheet including a conductive metal onto the body 100, or by transferring a sheet including a conductive metal onto a sintered electrode.

The conductive metal included in the electrode layers 131 and 141 may be any material having excellent electrical conductivity, and is not particularly limited. For example, the conductive metal may be one or more of nickel (Ni), copper (Cu) or alloys thereof.

The plating layers 132, 133, 142 and 143 may improve sealing properties or mounting characteristics of the multilayer electronic component 1000. The type of plating layers 132, 133, 142 and 143 is not particularly limited, and may be plating layers including one or more of Ni, Sn, Pd, or alloys thereof, and may be comprised of a plurality of layers.

For more specific examples of the plating layers 132, 133, 142 and 143, the plating layers 132, 133, 142 and 143 may include a Ni plating layer including Ni or a Sn plating layer including Sn, and may have a shape in which a plating layer including Ni and a plating layer including Sn may be sequentially formed on the electrode layers 131 and 141, or may have a shape in which a plating layer including Sn, a plating layer including Ni, and a plating layer including Sn may be sequentially formed. Additionally, the plating layer may include a plurality of Ni plating layers and/or a plurality of Sn plating layers.

In a conventional example for achieving high capacitance in a multilayer electronic component 1000, an area of the first dielectric layer 111a may be formed to be larger than that of the internal electrodes 121 and 122, thereby forming a margin region in the remaining region, excluding a portion in which the internal electrodes 121 and 122 are connected to the external electrodes 130 and 140. In this case, a difference portion in the degree of lamination of the internal electrodes may cause the problem in which ends of the internal electrodes may be warped.

In another conventional example for achieving high capacitance in a multilayer electronic component 1000, separate sheets may be attached to the fifth side surface S5 and the sixth side surface S6 of the stack body 110 to form a margin region, and may be attached to the first side surface S1 and the second side surface S2 to form a cover region. In this case, due to differences in shrinkage and expansion rates between the margin portion and the stack body 110 or the cover portion and the stack body 110, boundaries between the margin portion and the stack body 110 or the cover portion and the stack body 110 may be subjected to mechanical stress in a parallel direction, which may result in cracks due to shrinkage and expansion, and boundaries between the margin portion and the stack body 110 or the cover portion and the stack body 110 may serve as a path for moisture penetration, which may result in a decrease in the moisture resistance reliability of the multilayer electronic component 1000.

In the multilayer electronic component 1000 according to an example embodiment of the present disclosure, the protection portion 114 may be disposed on the stack body 110 in which the first dielectric layer 111a and the internal electrodes 121 and 122 are alternately disposed, and thus, there is no need to form an area of the first dielectric layer 111a to be larger than that of the internal electrodes 121 and 122, as in the conventional example. Accordingly, the warpage phenomenon of the ends of the internal electrodes 121 and 122 of the multilayer electronic component 1000 according to an example embodiment of the present disclosure may be mitigated.

Meanwhile, since the mechanical stress acting on the protection portion 114 according to an example embodiment of the present disclosure is perpendicular to the mechanical stress acting along an outer surface of the stack body 110, an occurrence of cracks due to differences in shrinkage and expansion rates at the boundaries between the stack body 110 and the protection portion 114 may be reduced, and the phenomenon in which external moisture penetration pathways may occur may be reduced. Accordingly, the occurrence of cracks in the multilayer electronic component 1000 according to an example embodiment of the present disclosure may be suppressed or mitigated, and the moisture resistance reliability of the multilayer electronic component 1000 may be improved.

Meanwhile, the multilayer electronic component 1000 according to an example embodiment of the present disclosure may include a protection portion 114 disposed on the stack body 110. The protection portion 114 may be formed of the same dielectric material as a dielectric first layer 111, and thus, the protection portion 114 may include dielectric grains. In an example embodiment of the present disclosure, as the protection portion 114 is disposed on the stack body 110, as compared to a conventional art of forming the cover portion and the margin portion separately on the stack body 110, the stress generated due to the difference in shrinkage between the stack body 110 and the protection portion 114 may be effectively dispersed, through which the mechanical strength of the multilayer electronic component 1000 may be improved.

The protection portion 114 of the multilayer electronic component 1000 according to an example embodiment of the present disclosure may include a first region 114a in contact with the stack body 110 and a second region 114b disposed on the first region 114a.

More specifically, referring to FIGS. 2 and 4, the first region 114a may be disposed to be in contact with the stack body 110 and to surround the first side surface S1, the second side surface S2, the fifth side surface S5 and the sixth side surface S6, and the second region 114b may be disposed to be in contact with the first region 114a and to surround the first region 114a.

In an example embodiment of the present disclosure, the first region 114a and the second region 114b may be distinguished based on differences in an average grain size or average density.

Specifically, in an example embodiment, when the average grain size of the first region 114a is defined as G1 and the average grain size of the second region 114b is defined as G2, G1 and G2 may be different. That is, the protection portion 114 may be divided into a first region 114a and a second region 114b based on the average grain size.

Meanwhile, in an example embodiment, when the average density of the first region 114a is defined as D1 and the average density of the second region 114b is defined as D2, D1 and D2 may be different. That is, the protection portion 114 may be divided into a first region 114a and a second region 114b based on the average density.

In an example embodiment of the present disclosure, the protection portion 114 may be divided into a first region 114a in contact with the stack body and a second region 114b disposed on the first region 114a, and the average grain sizes G1 and G2 or the average densities D1 and D2 of the first region 114a and the second region 114b may vary, so that the protection portion 114 may be formed in multiple layers in stages, and the characteristics of each region may be controlled differently.

Two or more surfaces of the first surface 1, the second surface 2, the fifth surface 5 and the sixth surface 6 of the multilayer electronic component 1000 according to an example embodiment of the present disclosure may include concave portions R and R’ having a concave shape toward the stack body 110. Accordingly, a structure in which two or more dielectric sheets having different compositions or microstructures are wound around a stack body 110 may be implemented, and stress may be effectively dispersed due to sintering shrinkage differences between the stack body 110 and the protection portion 114, and thus, the reliability of the multilayer electronic component 1000 may be improved.

The average grain sizes G1 and G2 of the first region 114a and the second region 114b may be measured from images obtained by observing first and third directional cross-sections using a scanning electron microscope (SEM) by polishing the multilayer electronic component 1000 to a 1/2 point in the second direction.

Specifically, the average grain sizes G1 and G2 of the first region 114a and the second region 114b may be a value obtained by averaging circle-equivalent diameters measured in central portions of the first region 114a and the second region 114b disposed on each of the first side surface S1, the second side surface S2, the fifth side surface S5 and the sixth side surface S6 of the stack body 110, by dividing a region from a surface of the protection portion 114 toward the stack body 110 to an outer surface of the protection portion 114 into two equal parts so that a region adjacent to the stack body 110 is designated as the first region 114a and a region adjacent to the outer surface of the stack body 110 is designated as the second region 114b. Meanwhile, the number of regions into which a region from a surface toward the stack body 110 of the protection portion 114 to the outer surface of the protection portion 114 is divided may vary depending on the number of turns of a dielectric sheet for forming the first region 114a and the second region 114b.

Meanwhile, in this specification, “G1” and “G2” being different may mean that “G1/G2” is 1.1 or more, or “G2/G1” is 1.1 or more, but the present disclosure is not limited thereto.

The average densities D1 and D2 of the first region 114a and the second region 114b may be measured in the same region as a region in which the average grain sizes G1 and G2 are measured. However, the average densities D1 and D2 may be measured by taking a reciprocal of a proportion of pores in a unit area measured in each region, or taking a reciprocal of the number density of pores per unit area (Pore Number Density) measured in each region and calculating an average value thereof.

Meanwhile, in this specification, “D1” and “D2” being different may mean that “D1/D2” is 1.1 or more, or “D2/D1” is 1.1 or more, but the present disclosure is not limited thereto.

In an example embodiment, G1 and G2 may satisfy G1 > G2. That is, the first region 114a in direct contact with the stack body 110 may have a relatively smaller average grain size than the second region 114b, and the second region 114b in direct contact with the band portion of the external electrodes 130 and 140 may have a relatively larger average grain size than the first region 114a. This may alleviate mechanical stress caused by a sintering mismatch between the stack body 110 and the protection portion 114, and may improve bonding strength between the external electrodes 130 and 140 and the body 110.

In an example embodiment, D1 and D2 may satisfy D1 > D2. That is, the first region 114a in direct contact with the stack body 110 may be relatively denser than the second region 114b, and the second region 114b in direct contact with the band portions of the external electrodes 130 and 140 may be relatively less dense than the first region 114a. This may alleviate mechanical stress caused by the sintering mismatch between the stack body 110 and the protection portion 114, and may improve the bonding strength between the external electrodes 130 and 140 and the body 110.

Meanwhile, in an example embodiment, one or more of a condition G1 > G2 and a condition D1 > D2 may be satisfied, and to this end, the dielectric included in the protection portion 114 may include one or more of Na, Li or B. In this case, a content of one or more of Na, Li and B included in the first region 114a may be greater than a content of one or more of Na, Li and B included in the second region 114b. Accordingly, the first region 114a may be formed to have a larger average grain size or higher average density than the second region 114b.

Meanwhile, when the average grain size G1 of the first region 114a is equal to or greater than an average grain size G0 of the first dielectric layer 111a, problems such as stress unevenness may be caused during the sintering process. Accordingly, in an example embodiment, when the average dielectric grain size of the first dielectric layer 111a is defined as G0, G0 > G1 may be satisfied to alleviate the uneven stress distribution within the body 110, thereby suppressing delamination and cracking of the multilayer electronic component 1000.

In an example embodiment, G0, G1 and G2 may satisfy a condition G0 > G1 > G2. This may alleviate mechanical stress caused by the sintering mismatch between the stack body 110 and the protection portion 114, and may improve the bonding strength between the external electrodes 130 and 140 and the body 110 as well as suppressing delamination and cracking of the multilayer electronic component 1000 by alleviating uneven stress distribution within the body 110.

When an average density D1 of the first region 114a is equal to or greater than an average density D0 of the first dielectric layer 111a, problems such as uneven stress may be caused during the sintering process. Accordingly, in an example embodiment, when the average density of the first dielectric layer 111a is defined as D0, D0 > D1 may be satisfied to alleviate the uneven stress distribution within the body 110, thereby suppressing an occurrence of delamination and cracks in the multilayer electronic component 1000.

According to an example embodiment, D0, D1 and D2 may satisfy the condition D0 > D1 > D2. This may alleviate mechanical stress caused by the sintering mismatch between the stack body 110 and the protection portion 114, and may improve the bonding strength between the external electrodes 130 and 140 and the body 110, as well as suppressing delamination and cracks in the multilayer electronic component 1000 by alleviating the uneven stress distribution within the body 110.

That is, the multilayer electronic component 1000 according to an example embodiment may improve the bonding strength between the external electrodes 130 and 140 and the body 110 by satisfying one or more of a condition G0 > G1 > G2 and a condition D0 > D1 > D2, as well as suppressing the occurrence of delamination and cracks in the multilayer electronic component 1000 by alleviating the uneven stress distribution within the body 110.

The average dielectric grain size G0 and the average density D0 of the first dielectric layer 111a may be measured from images obtained by observing first and third directional cross-sections using the scanning electron microscope (SEM) after polishing the multilayer electronic component 1000 to the 1/2 point in the second direction.

Specifically, the average dielectric grain size G0 of the first dielectric layer 111a may refer to an average value of an equivalent circle diameter of the dielectric grains measured in a central region of the capacitance formation portion Ac, and the average density D0 may refer to an average value of a reciprocal of a proportion of pores (Pore Area Fraction) or a reciprocal of the number of pores per unit area (Pore Number Density) measured in the central region of the capacitance formation portion Ac.

In an example embodiment, the concave portions R and R’ may be disposed continuously in the second direction, or may be disposed from one end of the body 100 in the second direction to the other end of the body 100 in the second direction. Accordingly, a structure in which two or more dielectric sheets having different compositions or microstructures are wound around the stack body 110 may be implemented, and stress may be effectively dispersed due to sintering shrinkage differences between the stack body 110 and the protection portion 114, and the protection portion 114 may be formed integrally to improve the moisture resistance reliability of the multilayer electronic component 1000.

In an example embodiment, the protection portion 114 may be disposed to surround the stack body 110, and more specifically, the protection portion 114 may be disposed to surround the first side surface S1, the second side surface S2, the fifth side surface S5 and the sixth side surface S6. Accordingly, the first side surface S1, the second side surface S2, the fifth side surface S5 and the sixth side surface S6 of the stack body 110 may not be exposed externally, and the moisture resistance reliability of the multilayer electronic component 1000 may be secured.

A corner of the protection portion 114 according to an example embodiment may have a round shape. Accordingly, stress that may be concentrated on a corner of the body 100 may be dispersed to reduce the possibility of cracks occurring in the multilayer electronic component 1000. The rounded corner of the protection portion 114 may be formed naturally when a first dielectric layer 111b surrounding the stack body 110 is wrapped around the stack body 110, but the present disclosure is not limited thereto, and a method of separately polishing a surface of the body 100 may also be used.

In an example embodiment, the protection portion 114 may cover third directional ends of the internal electrodes 121 and 122. Accordingly, the internal electrodes 121 and 122 may not be exposed externally, and a short circuit between the internal electrodes 121 and 122 and the external electrodes 130 and 140 may be prevented.

The protection portion 114 may include a dielectric material, and specifically, may include a BaTiO₃-based dielectric material. That is, the protection portion 114a according to an example embodiment may include Ba and Ti.

Meanwhile, the protection portion 114 may include various additive elements in addition to Ba and Ti. Examples of additive elements included in the protection portion 114 include one or more of Na, Li or B, and the additive elements may be included in the protection portion 114 to improve the sintering properties of the protection portion 114 to enhancing density thereof and to improve mechanical strength.

The proportions of the first region 114a and the second region 114b relative to the entire protection portion 114 may be adjusted differently depending on the region.

In an example embodiment, when the average density D1 of the first region 114a is greater than the average density D2 of the second region 114b (D1 > D2), a maximum thickness of the second region 114b may be greater than a maximum thickness of the first region 114a. This further may improve the bonding strength between the body 100 and the external electrodes 130 and 140.

In an example embodiment, when the average density D1 of the first region 114a is greater than the average density D2 of the second region 114b (D1 > D2), a maximum thickness of the second region 114b may be less than the maximum thickness of the first region 114a. This may further improve the effect of the present disclosure in alleviating stress imbalance between the stack body 110 and the protection portion 114.

Meanwhile, the protection portion 114 may include dielectric layers 111b and 111c, and the dielectric layers 111b and 111c of the protection portion 114 may be divided into a second dielectric layer 111b included in the first region 114a and a third dielectric layer 111c included in the second region 114b.

Furthermore, the average grain sizes G1 and G2 for each region of the protection portion 114 may refer to average dielectric grain sizes of the second dielectric layer 111b and the third dielectric layer 111c, respectively.

Meanwhile, the second dielectric layer 111b and the third dielectric layer 111c may be present in plural in each region of the protection portion 114. How many layers of dielectric layers each region of the protection portion 114 is comprised of may be determined by observing differences in grain orientation or density using a scanning electron microscope (SEM) or a transmission electron microscope (TEM).

Referring to FIGS. 1-8, a multilayer electronic component 1000 according to an example embodiment of the present disclosure may include concave portions R and R’ in which two or more surfaces of the first surface 1, the second surface 2, the fifth surface 5 and the sixth surface 6 have a concave shape toward the stack body 110.

Two or more surfaces among the first surface 1, the second surface 2, the fifth surface 5 and the sixth surface 6 described above may be the fifth surface 5 and the sixth surface 6 in the multilayer electronic component 1000 according to an example embodiment, and may be the first surface 1 and the second surface 2 in the multilayer electronic component 1000’ according to an example embodiment, but the present disclosure is not limited thereto.

A method of forming the concave portions R and R’ on two or more surfaces among the first surface 1, the second surface 2, the fifth surface 5 and the sixth surface 6 is not particularly limited. For example, a formation position of the concave portions R and R’ may be controlled by varying positions of winding start and end points of a first protection sheet 214a and winding start and end points of a second protection sheet 214b during a process of forming a second cut bar 220 by winding a first cut bar 210 described below around the first protection sheet 214a, and forming a third cut bar 230 by winding the second cut bar 220 around the second protection sheet 214b. Furthermore, when the concave portions R and R’ are formed on more than two surfaces thereof, a process of winding the third protection sheet around the third cut bar 230 may be repeated repeatedly.

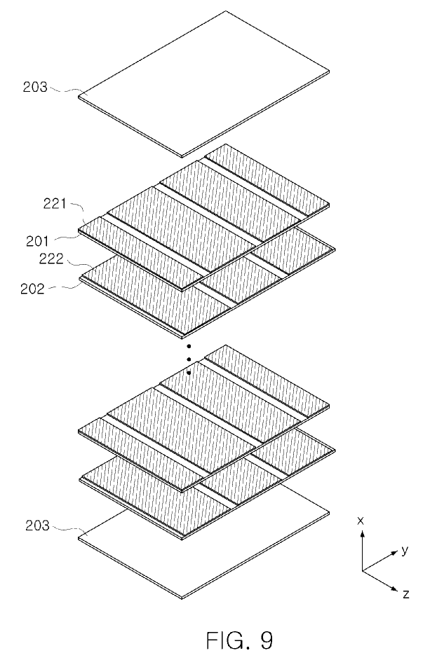

FIG. 9 schematically illustrates an operation of stacking a dielectric sheet and an internal electrode pattern according to an example embodiment.

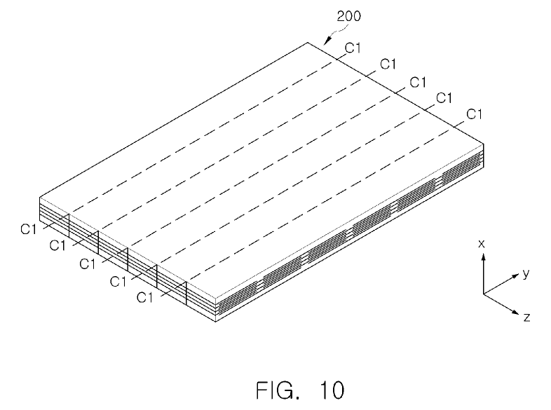

FIG. 10 schematically illustrates an operation of cutting a stack bar according to an example embodiment.

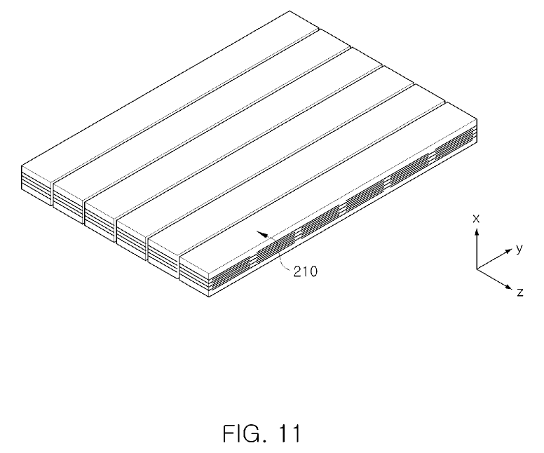

FIG. 11 schematically illustrates a state in which a first cut bar is formed after an operation of cutting a stack bar according to an example embodiment is performed.

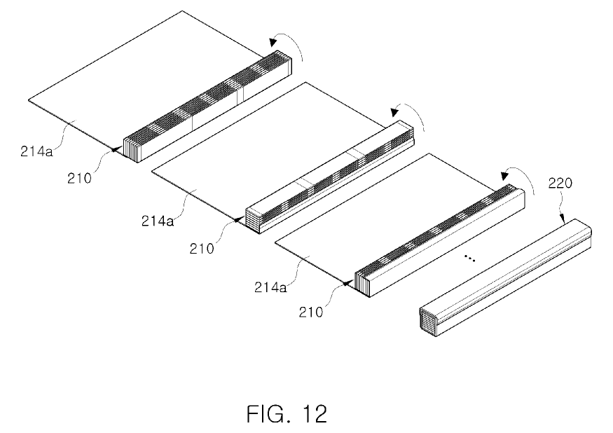

FIG. 12 schematically illustrates an operation of forming a second cut bar by wrapping a first protection sheet around a first cut bar according to an example embodiment.

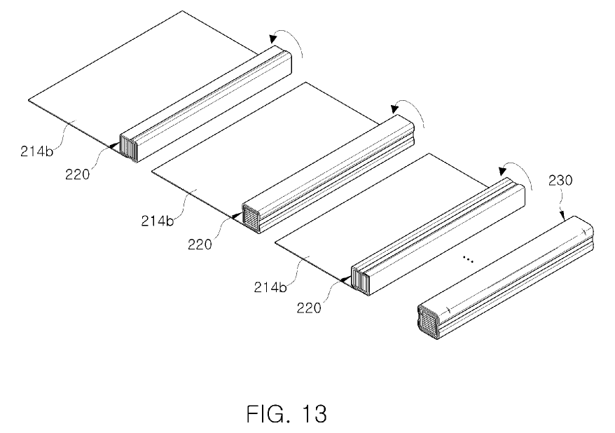

FIG. 13 schematically illustrates an operation of forming a third cut bar by wrapping a second protection sheet around a second cut bar according to an example embodiment.

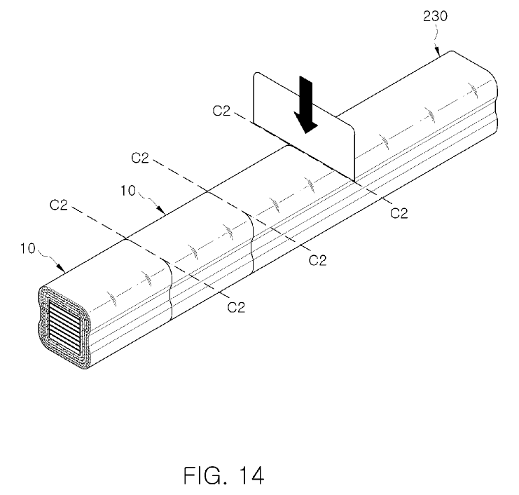

FIG. 14 schematically illustrates an operation of forming an unsintered body by cutting the third cut bar.

Hereinafter, with reference to FIGS. 9-14, an example of a method of manufacturing the multilayer electronic components 1000 and 1000′ according to an embodiment of the present invention will be described in detail. However, the multilayer electronic components 1000 and 1000’ according to an example embodiment of the present disclosure or various embodiments thereof is not limited to the manufacturing method described below.

Referring to FIG. 9, internal electrode patterns 221 and 222 may be formed on dielectric sheets 201 and 202, and the internal electrode patterns 221 and 222 disposed on the dielectric sheets 201 and 202 may be repeatedly stacked. A cover sheet 203 may be disposed on a plurality of stacked dielectric sheets 201 and 202 and internal electrode patterns 221 and 222.

The dielectric sheets 201 and 202 may be formed from a ceramic paste including ceramic powder particles, an organic solvent, a dispersant and a binder. The ceramic powder particles is a raw material for forming the first dielectric layer 111a of the multilayer electronic component 1000, and a barium titanate-based material, a lead composite perovskite-based material, or a strontium titanate-based material may be used as the ceramic powder particles.

The cover sheet 203 may be formed of the same material as the dielectric sheets 201 and 202, and may be formed of the same materials and components, but the present disclosure is not limited thereto, and upper and lower cover portions 112 and 113 of the body 100 may be formed through a sintering process.

The components of the internal electrode patterns 221 and 222 may be formed on the dielectric sheets 201 and 202 using an internal electrode paste including a conductive metal. The conductive metal included in the conductive patterns 221 and 222 is not particularly limited, and any material having excellent electrical conductivity may be used. For example, the conductive metal may include one or more of nickel (Ni), copper (Cu), palladium (Pd), silver (Ag), gold (Au), platinum (Pt), tin (Sn), tungsten (W), titanium (Ti) or alloys thereof. The internal electrode patterns 221 and 222 may be formed by screen-printing or gravure-printing a conductive paste onto the dielectric sheets 201 and 202.

The internal electrode patterns 221 and 222 may be formed in the form of stripes in which a plurality of conductive patterns are spaced apart from each other by substantially equal intervals. The spaced intervals of the first internal electrode pattern 221 and the spaced patterns of the second internal electrode pattern 222 may be disposed so as to be offset from each other when viewed in the stacking direction.

Referring to FIGS. 10 and 11, the plurality of stacked dielectric sheets 201 and 202, the internal electrode patterns 221 and 222 and the cover sheet 203 may be compressed together to form a stack bar 200. After forming the stack bar 200, the stack bar 200 may be cut along line C1-C1 to form a first cut bar 210. The method of cutting the stack bar 200 is not particularly limited, and examples thereof include a blade cutting method using a doctor blade, dicing blade, or the like, a guillotine cutting method, or a laser cutting method.

Referring to FIG. 12, after forming the first cut bar 210, an operation of winding the first protection sheet 214a around a surface of the first cut bar 210 to form a second cut bar 220 may be performed.

The first protection sheet 214a may be a single dielectric sheet, and thus, the first region 114a of the multilayer electronic components 1000 and 1000’ according to an example embodiment may be integrally formed on the first side surface S1, the second side surface S2, the fifth side surface S5, and the sixth side surface S6 of the stack body 110.

Meanwhile, the first protection sheet 214a need not necessarily be a single dielectric sheet, but may have a shape in which a plurality of dielectric sheets are stacked.

A first protection sheet 214a may differ from the dielectric sheets 201 and 202 in one or more of a composition and/or a microstructure. Specifically, the type and content of additive elements other than the BaTiO₃-based material may differ, and the size of the dielectric powder included in each sheet may differ.

The first protection sheet 214a may be wound around the cut bar 210 as a central axis. A process of winding the first protection sheet 214a around the cut bar 210 as a central axis may be continuously performed even after a surface of the cut bar 210 is completely covered with the protection sheet 214a.

Referring to FIG. 13, after forming the second cut bar 220, an operation of forming a third cut bar 230 by winding the second protection sheet 214b around a surface of the second cut bar 220 may be performed.

The second protection sheet 214b may be a single dielectric sheet, but need not necessarily be a single dielectric sheet and may have a form in which a plurality of dielectric sheets are stacked.

The second protection sheet 214b may differ from the dielectric sheets 201 and 202 and the first protection sheet 214a in one or more of the composition and/or the microstructure. Specifically, the type and content of additive elements other than the BaTiO₃-based material may differ, and the size of the dielectric powder included in each sheet may differ.

The second protection sheet 214b may be wound around the second cut bar 220 as a central axis. A process of winding the second protection sheet 214b around the second cut bar 220 as a central axis may be continuously performed even after the surface of the second cut bar 220 is completely covered with the second protection sheet 214b.

Referring to FIG. 14, after forming the third cut bar 230, an operation of cutting the third cut bar 230 to form an unsintered body 10 may be performed. The operation of forming the unsintered body 10 may be performed by cutting the third cut bar 230 along line C2-C2, and the method of cutting the third cut bar 230 is not particularly limited. For example, the third cut bar 230 may be cut using a cutting method such as a doctor blade, a dicing blade, or the like, a guillotine cutting method, or a laser cutting method.

After the operation of forming the unsintered body 10, an operation of sintering the unsintered body 10 to form the body 100 may be performed. A sintering temperature is not particularly limited, but may be, for example, sintered at 1000 to 1300° C. In addition, the sintering may be performed in a reducing atmosphere.

Then, external electrodes 130 and 140 may be formed on the third and fourth surfaces 3 and 4 of the body 100, respectively, to manufacture the multilayer electronic component 1000.

Meanwhile, the sintering operation of the unsintered body 10 may be performed before the formation of the external electrodes 130 and 140, but the present disclosure is not limited thereto, and a conductive paste including a metal having excellent electrical conductivity may be formed on an exposed surface of the internal electrode pattern of the unsintered body 10, respectively, and may be simultaneously sintered together with the body 100, thereby manufacturing multilayer electronic components 1000 and 1000’.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including a stack body including a first dielectric layer and an internal electrode alternately disposed with the first dielectric layer in a first direction, and a protection portion disposed on the stack body and including dielectric grains, and including a first surface and a second surface opposing each other in the first direction, a third surface and a fourth surface connected to the first surface and the second surface and opposing each other in a second direction, and a fifth surface and a sixth surface connected to the first to fourth surfaces and opposing each other in a third direction; and
an external electrode disposed on the third surface and the fourth surface and connected to the internal electrode,
wherein the protection portion includes a first region in contact with the stack body, and a second region disposed on the first region,
when an average density of the first region is defined as D1 and an average density of the second region is defined as D2, D1 and D2 are different, and
one or more surfaces of the first surface, the second surface, the fifth surface or the sixth surface include a concave portion having a concave shape toward the stack body.

2. The multilayer electronic component according to claim 1, wherein the concave portion is continuously disposed in the second direction.

3. The multilayer electronic component according to claim 1, wherein the concave portion is disposed from one end of the body in the second direction to the other end of the body in the second direction.

4. The multilayer electronic component according to claim 1, wherein the protection portion is disposed to surround the stack body.

5. The multilayer electronic component according to claim 1, wherein the concave portion is included in the fifth surface and the sixth surface.

6. The multilayer electronic component according to claim 1, wherein the concave portion is included in the first surface and the second surface.

7. The multilayer electronic component according to claim 1, wherein D1 > D2 is satisfied.

8. The multilayer electronic component according to claim 1, wherein when an average density of the first dielectric layer is defined as D0, D0 > D1 > D2 is satisfied.

9. The multilayer electronic component according to claim 1, wherein a condition of G1 > G2 is satisfied.

10. The multilayer electronic component according to claim 1, wherein the first dielectric layer includes dielectric grains, and
when an average grain size of the first dielectric layer is defined as G0,
G0 > G1 > G2 is satisfied.

11. The multilayer electronic component according to claim 1, wherein the protection portion includes Ba and Ti, and further includes one or more of Na, Li or B.

12. The multilayer electronic component according to claim 11, wherein a content of one or more of Na, Li or B in the first region is greater than a content of one or more of Na, Li or B in the second region.

13. The multilayer electronic component according to claim 1, wherein a corner of the protection portion has a round shape.

14. The multilayer electronic component according to claim 1, wherein D1 > D2 is satisfied, and a maximum thickness of the second region is greater than a maximum thickness of the first region.

15. The multilayer electronic component according to claim 1, wherein D1 > D2 is satisfied, and a maximum thickness of the second region is less than a maximum thickness of the first region.

16. The multilayer electronic component of claim 1, wherein each external electrode comprises an electrode layer in contact with the body and a plating stack including a Ni plating layer on the electrode layer and a Sn plating layer on the Ni plating layer.

17. The multilayer electronic component according to claim 1, wherein an average thickness (td) of the first dielectric layer is 0.35 µm or less.
